(19) United States
(12) Patent Application Publication
(10) Pub. No.: US 2024/0207877 A1
(43) Pub. Date: Jun. 27, 2024

(54) Adjustable Unloader Control

(71) Applicant: J. D. North America Corp., Waukesha, WI (US)

(72) Inventors: Paul Janik, Saukville, WI (US); Joseph Glacalone, Hartland, WI (US)

(21) Appl. No.: 18/393,898

(22) Filed: Dec. 22, 2023

Related U.S. Application Data
(60) Provisional application No. 63/434,615, filed on Dec. 22, 2022.

(51) Int. Cl. B05B 12/00; B08B 3/02

(52) U.S. Cl. CPC B05B 12/002; B08B 3/028; B08B 2203/027

(57) ABSTRACT

Systems and methods for an adjustable unloader control are provided. The adjustable unloader control may be used with a pressure washer system, or any other liquid container configured to dispense liquid. The system includes an adjustable pressure knob that restricts flow rate and pressure of the liquid from the container, as well as an accompanying pump. The adjustable pressure knob is preferably rotated 360 degrees or less, meaning that a user can move the system from a closed position to a fully opened position with a single rotation of the knob. This enables a user to quickly and easily activate or deactivate the flow of liquid from the pressure washer or other device. The knob may also be moved to intermediate positions between the fully opened and closed positions. The system may enable flow rates of approximately 2-4 gallons per minute, and pressures of between 40-3,500 pounds per square inch.

### CROSS-REFERENCE(S) TO RELATED APPLICATION(S)

This application claims the benefit of priority on U.S. Provisional Patent Application Ser. No. 63/434,615, filed on Dec. 22, 2022 and entitled Adjustable Unloader Control, the entirety of which is hereby incorporated by reference.

### BACKGROUND OF THE INVENTION

### 1. Field of the Invention

The present invention relates in general to the field of flow of liquid from a container. More particularly, the present invention relates to an easy to use adjustment control that is used with the container to dispense liquid from the container. Specifically, a preferred embodiment of the present invention relates to an adjustment control that can be rotated 360 degrees or less to move the control from a fully closed to a fully opened orientation.

### 2. Discussion of the Related Art

A variety of containers used to transport and then dispense liquids or other materials are well known. For example, pressure washers are containers that are commonly used to transport water, cleaning solution, or another material to a given location that needs to be sprayed or otherwise cleaned. Once the pressure washer reaches a given location, a valve, controller, or other device can be opened or closed to enable the liquid to be sprayed out of the pressure washer at a desired pressure or flow rate. More specifically, traditional pressure washers include valves or controllers that require a handle or other device to be rotated multiple times to achieve a maximum amount of pressure or flow rate. This can be burdensome in that it takes significant time and effort to move the pressure washer from the minimum position to the maximum position. Similarly, it takes a significant amount of time and effort to move the handle from a maximum flow rate to a minimum flow rate. This can be problematic when a user needs to quickly and easily minimize the amount of flow out of the pressure washer. This is especially true when using a pressure washer, which oftentimes spray the liquid at a significant volume, which can cause damage to property and be dangerous when bystanders are nearby. Further still, where the handle is rotated multiple times, it can be difficult to gauge how much flow and pressure is present without fully turning on or off the handle, or using an exterior pressure or flow measuring device.

Similar issues occur for other devices used to dispense liquids. For instance, most water outlets associated with homes or other buildings require a handle to be rotated multiple times in order to maximize flow of water, or discontinue flow of water from the outlet.

What is therefore needed is an adjustable unloader control that enables a user to quickly and easily change the flow and pressure of a liquid flowing from a container, pipe, or hose. What is further needed is an adjustable unloader control that can quickly and easily be moved from a minimum flow rate to a maximum flow rate. For instance, in one embodiment, the adjustable unloader control can be moved from a minimum position to a maximum position in 360 degrees or less.

### SUMMARY AND OBJECTS OF THE INVENTION

By way of summary, the present invention is directed to an adjustable unloader control system for use with a container configured to receive a volume of liquid, such as a pressure washer. The system also includes a pump configured to pump the liquid from the container, as well as a dispenser attached to the container. Further still, the system includes an adjustable pressure knob or handle located between the container and the dispenser.

According to an aspect of the present invention, the adjustable pressure knob may be configured to only be rotated 360 degrees or less. For instance, the adjustable pressure knob may be adjustable between a first opened position and a second closed position. When in the first opened position, the adjustable pressure knob is at a substantially 1 degree angle relative to the Y-axis. When in this position, liquid is pumped from the container to the dispenser at a maximum or substantially maximum pressure. When in the second closed position, the adjustable pressure knob is at a substantially 359 degree angle relative to the Y-axis. When in this position, liquid is pumped from the container to the dispenser at a minimum or substantially minimum pressure. Additionally, the adjustable pressure knob may be adjustable to a plurality of intermediate positions between the first opened position and the second closed position. For instance, in one embodiment, the knob can be continuously adjusted between the first position and the second position. In another embodiment, the knob can be biased towards a plurality of preset locations located between the first position and the second position. By way of example, the knob may be biased to a single intermediate position in which it is located at a substantially 180 degree angle relative to the Y-axis, in which flow rate and/or pressure is substantially 50% of the total flow rate and/or pressure. In another embodiment, the knob may be biased to three intermediate positions, with one being at a substantially 90 degree angle relative to the Y-axis, in which flow rate and/or pressure is substantially 25% of the total flow rate and/or pressure; the next being at a substantially 180 degree angle relative to the Y-axis, in which flow rate and/or pressure is substantially 50% of the total flow rate and/or pressure; and a third being at a substantially 270 degree angle relative to the Y-axis, in which flow rate and/or pressure is substantially 75% of the total flow rate and/or pressure. Further still, the adjustable pressure knob may be rotated in a clockwise direction to increase the pressure of the liquid flowing from the container, and the knob may be rotated in a counterclockwise direction to decrease the pressure of the liquid flowing from the container.

According to another aspect of the present invention, the pump may be an axial pump or a triplex pump. The pump may have a flow rate of between approximately 1-5 gallons per minute, and more preferably between approximately 2-4 gallons per minute. The pump may also pump the liquid from the container at approximately 10-5,000 pounds per square inch, and more preferably between approximately 40-3,500 pounds per square inch. The pressure may increase linearly while adjusting the knob, such that the pressure is substantially 50% when the knob is rotated 180 degrees. In other embodiments, the pressure may increase non-linearly while adjusting the knob.

According to yet another aspect of the invention, a method of using a pressure washer system is provided. The method may include the steps of filling a container with a volume of liquid, controlling flow of the liquid from the container, rotating an adjustable pressure knob between 1 degree and 360 degrees to enable flow of the liquid from the container, and pumping at least some of the volume of liquid from the container. The method may further comprise the step of moving the adjustable pressure knob between a first opened position in which the adjustable pressure knob is at a substantially 359 degree angle relative to the Y-axis in which the liquid is pumped from the container and a second closed position in which the adjustable pressure knob is at a substantially I degree angle relative to the Y-axis in which the liquid remains within the container. The method may also include the step of moving the adjustable knob to a plurality of intermediate positions between the first opened position and the second closed position. The method may also include the steps of pumping the liquid at a flow rate of between approximately 2-4 gallons per minute and at a pressure of approximately 40-3,500 pounds per square inch.

According to yet another aspect of the present invention, an adjustable unloader control system is provided that includes a container configured to receive a volume of liquid, as well as an adjustable pressure knob configured to only be rotated 360 degrees or less.

These, and other aspects and objects of the present invention will be better appreciated and understood when considered in conjunction with the following description and the accompanying drawings. It should be understood, however, that the following description, while indicating preferred embodiments of the present invention, is given by way of illustration and not of limitation. Many changes and modifications may be made within the scope of the present invention without departing from the spirit thereof, and the invention includes all such modifications.

### BRIEF DESCRIPTION OF THE DRAWINGS

A clear conception of the advantages and features constituting the present invention, and of the construction and operation of typical mechanisms provided with the present invention, will become more readily apparent by referring to the exemplary, and therefore non-limiting, embodiments illustrated in the drawings accompanying and forming a part of this specification, wherein like reference numerals designate the same elements in the several views, and in which:

FIG. 1 illustrates a perspective view of the inventive adjustable unloader control as shown in use with a pressure washer;

FIG. 2A illustrates a detailed perspective view of the adjustable unloader control of FIG. 1;

FIG. 2B illustrates a detailed perspective view of the adjustable unloader control of FIG. 2A being rotated;

FIG. 3 illustrates a side elevation view of the inventive adjustable unloader control;

FIG. 4 illustrates a side sectional elevation view of the inventive adjustable unloader control;

FIG. 5A is a top plan view of the adjustable unloader control in a first position;

FIG. 5B is a top plan view of the adjustable unloader control in a second position;

FIG. 5C is a top plan view of the adjustable unloader control in a third position; and

FIG. 6 is a conventional handle associated with a pressure washer appropriately labeled “PRIOR ART.

In describing the preferred embodiment of the invention which is illustrated in the drawings, specific terminology will be resorted to for the sake of clarity. However, it is not intended that the invention be limited to the specific terms so selected and it is to be understood that each specific term includes all technical equivalents which operate in a similar manner to accomplish a similar purpose. For example, the word connected, attached, or terms similar thereto are often used. They are not limited to direct connection but include connection through other elements where such connection is recognized as being equivalent by those skilled in the art.

### DESCRIPTION OF PREFERRED EMBODIMENTS

The present invention and the various features and advantageous details thereof are explained more fully with reference to the non-limiting embodiments described in detail in the following description.

### 1. System Overview

An easy-to-use adjustment unloader control is provided for changing the flow rate and pressure of liquid flowing out of a container, such as a pressure washer. The adjustment unloader control can be rotated up to 360 degrees when moving the control from a minimum position to a maximum position to simplify turning on and off the pressure washer or other device, as well as to vary the flow rate and pressure as needed. In addition to simplifying use, the present invention is also advantageous in that it makes it easy for a user to quickly and easily understand the flow rate and pressure based on where the control is at based on a 360 degree total range of movement. Different styled knobs could be used for manipulating the mechanical components of the unloader.

### 2. Detailed Description of Preferred Embodiments

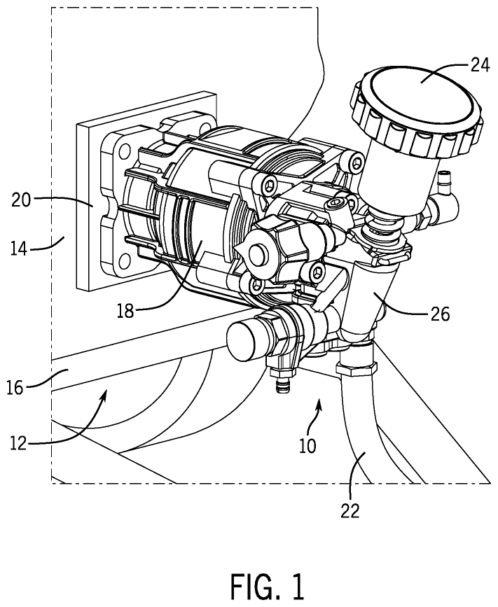

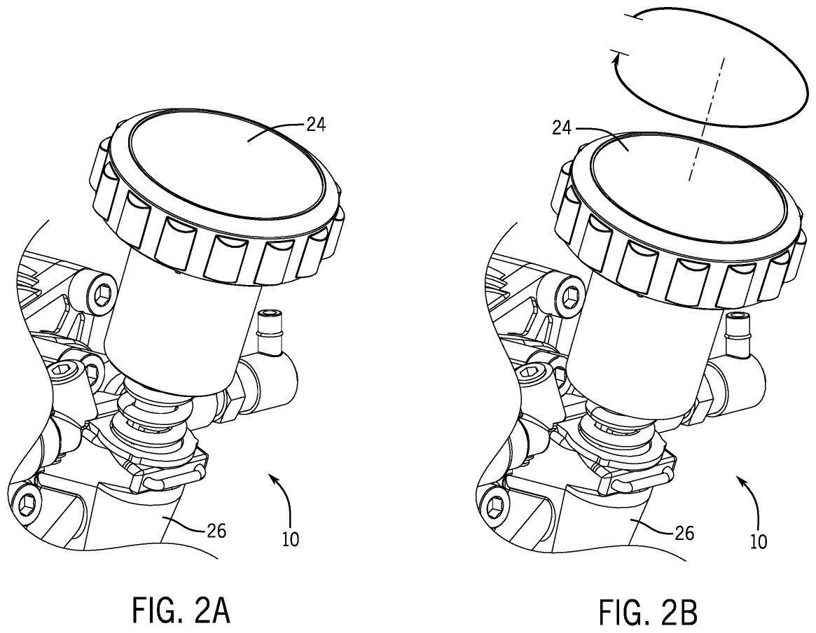

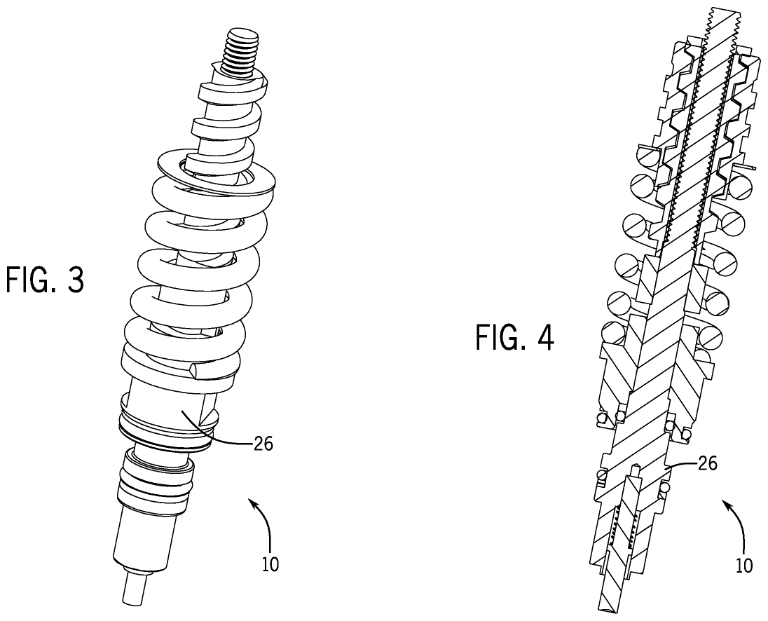

The present invention is directed to an adjustable unloader control 10 for use with a container of liquid or other material as shown in FIGS. 1-5C. As shown in the figures and described herein, the adjustable unloader control 10 will be described in connection with a pressure washer 12, although it should be understood that the control 10 could similarly be used with other containers, pipes, devices, and the like that distribute liquid or other materials to a given location.

The pressure washer 12 includes a storage container 14 configured to receive liquid such as water, soap, and the like, supported by a frame 16. The pressure washer 12 further includes a pump 18 contained within or adjacent to the container 14 in order to pump liquid from within the storage container 14. Any number of different pumps may be used based on the requirements of the pressure washer 12 and the desires of the user. In the illustrated embodiment, an axial piston pump is used, alternatively a triplex pump may be used. Potential flow rates of the axial piston pump could be between approximately 1-5 gallons per minute, and more preferably between approximately 2-4 gallons per minute. The pump 18 may pump the liquid at any number of different pressures, for instance between 10-5,000 pounds per square inch, and more preferably between 40-3,500 pounds per square inch.

The pump 18 may be powered by an engine or motor 20. Any engine or motor known in the prior art, including gasoline powered, electric powered, or the like could be used. The engine or motor 20 may be mounted to a portion of the frame 16 and/or the container 14. The liquid is pumped out of the storage container 14 to a hose 22, after which the liquid can either be dispensed directly out of the hose 22 through an opening, or through any number of accessories or dispensers that can be attached to the hose 22. The hose 22 is a high pressure hose configured to maintain sufficient pressure and flow of the liquid as desired by a user. Potential accessories can include various tips and/or wands configured to achieve different flow widths, patterns, angles, and the like.

Additionally, the frame 16 may be mounted to wheels to enable easy movement of the pressure washer 12 in certain embodiments, while in others the pressure washer 12 may be mounted to a trailer, truck, of other vehicle to enable movement of the pressure washer 12 from one location to another. A liquid source may be attached to the storage container 14 to provide continuous supply of the liquid, otherwise the storage container 14 may be of sufficient size that it can be operated for a period of time before additional liquid is provided. Although the pressure washer ultimately sprays liquid at a high pressure, the liquid source may be of low pressure, such as a water spigot associated with a house or other building.

The present invention further includes an adjustable knob or handle 24 associated with a valve 26 located where the liquid exits the storage container 14 and enters the dispenser hose 22. The knob 24 is configured to be easily manipulated in order to regulate flow from the container 14 independent of the flow characteristics and pressure of liquid exiting the pump 18. Stated differently, the knob 24 and valve 26 can be manipulated if desired to result in liquid leaving the pressure washer 12 at a pressure less than the pressure of the liquid when it leaves the pump 18. Advantageously, in a preferred embodiment the knob 24 has a maximum rotation of 360 degrees or less. This means that a user can toggle between an “off” position in which little or no liquid is flowing from the container 14 to a maximum position in which liquid is flowing from the container 14 at a maximum rate and pressure with one single 360 degree rotation of the knob 24. In other embodiments, the total rotation may be less than 360 degrees. The valve 26 and/or the pump 18 may also have a relief mechanism.

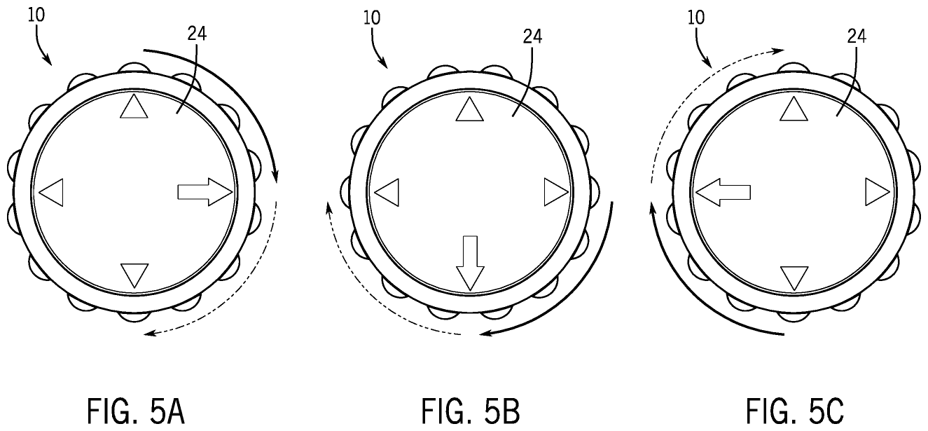

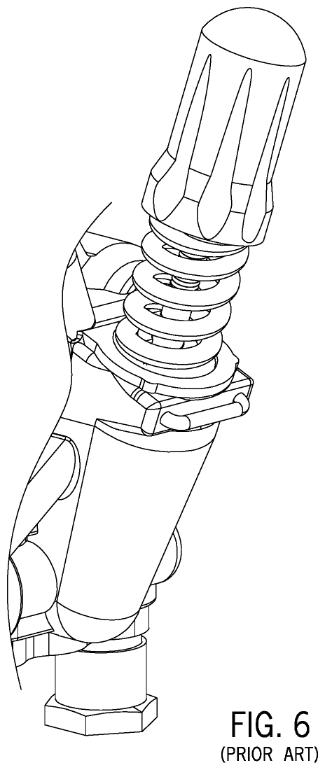

A user may twist the knob 24 the full 360 degrees, or an intermediate portion of the full rotation in the event that partial flow is desired between the maximum and minimum pressure. For instance, the knob 24 may be gradually rotated to any position within 360 degrees in certain embodiments. Typically, the pressure will increase linearly while the knob 24 is rotated, although in other embodiments the pressure increases non-linearly. In other embodiments, the knob 24 may be biased towards a number of preset locations. For instance, the knob 24 may be biased between the opened position, to another position approximately 180 degrees relative to the Y-axis which would constitute a 50% pressure, and to the closed position. In another embodiment, shown in FIGS. 5A-5C, the knob 24 may be biased between the opened position, to a position approximately 90 degrees relative to the Y-axis which would consisted a 75% pressure, to another position approximately 180 degrees relative to the Y-axis which would constitute a 50% pressure, to yet another position approximately 270 degrees relative to the Y-axis which would constitute 25% pressure, and to the closed position.

According to another aspect of the present invention, a method of using a pressure washer system includes the steps of filling a container with a volume off liquid, controlling flow of the liquid, pumping at least some of the volume of liquid from the container, and rotating an adjustable pressure knob between 1 degree and 360 degrees to enable flow of the liquid from the container. The knob can be moved from a first opened position to a second closed position, with a plurality of intermediate positions therebetween.

All the disclosed embodiments are useful in conjunction with storage, transportation, and pump of liquid from a container at a desired and easily changeable pressure. There are virtually innumerable uses for the present invention, all of which need not be detailed here. All the disclosed embodiments can be practiced without undue experimentation.

Although the best mode contemplated by the inventors of carrying out the present invention is disclosed above, practice of the present invention is not limited thereto. It will be manifest that various additions, modifications and rearrangements of the features of the present invention may be made without deviating from the spirit and scope of the underlying inventive concept.

In addition, the individual components need not be fabricated from the disclosed materials, but could be fabricated from virtually any suitable materials. Moreover, the individual components need not be formed in the disclosed shapes, or assembled in the disclosed configuration, but could be provided in virtually any shape, and assembled in virtually any configuration. Further, although the various components are described herein as being physically separate modules, it will be manifest that any of the components may be manufactured together or later assembled with one another. Furthermore, all the disclosed features of each disclosed embodiment can be combined with, or substituted for, the disclosed features of every other disclosed embodiment except where such features are mutually exclusive.

It is intended that the appended claims cover all such additions, modifications and rearrangements. Expedient embodiments of the present invention are differentiated by the appended claims.

What is claimed is:

1. A pressure washer system comprising:
a container configured to receive a volume of liquid;
a pump configured to pump the liquid from the container;
a dispenser attached to the container for distributing the liquid out of the container; and
an adjustable pressure knob between the container and the dispenser, the adjustable pressure knob configured to only be rotated 360 degrees or less.

2. The pressure washer system of claim 1, wherein the adjustable pressure knob is adjustable between:
a first opened position in which the adjustable pressure knob is at a substantially 1 degree angle relative to the Y-axis in which the liquid is pumped from the container to the dispenser; and
a second closed position in which the adjustable pressure knob is at a substantially 359 degree angle relative to the Y-axis in which the liquid remains within the container.

3. The pressure washer system of claim 2, wherein the adjustable pressure knob is adjustable in a plurality of intermediate positions between the first opened position and the second closed position.

4. The pressure washer system of claim 3, wherein pressure of the liquid increases as the adjustable pressure knob is moved from the opened position to the closed position.

5. The pressure washer system of claim 2, wherein the adjustable pressure knob is rotated in a clockwise direction to increase pressure of the liquid; and
wherein the adjustable pressure knob is rotated in a counter-clockwise direction to decrease the pressure of the liquid.

6. The pressure washer system of claim 2, further comprising a grip section associated with the adjustable knob.

7. The pressure washer system of claim 2, wherein the adjustable pressure knob is biased towards a plurality of preset locations between 1 degree and 359 degrees relative to the Y-axis.

8. The pressure washer system of claim 7, wherein the adjustable knob is biased towards:
a first position in which the adjustable knob is located at a substantially 1 degree angle relative to the Y-axis;
a second position in which the adjustable knob is located at a substantially 180 degrees angle relative to the Y-axis; and
a third position in which the adjustable knob is located at a substantially 359 degrees angle relative to the Y-axis.

9. The pressure washer system of claim 7, wherein the adjustable knob is biased towards:
a first position in which the adjustable knob is located at a substantially 1 degree angle relative to the Y-axis;
a second position in which the adjustable knob is located at a substantially 90 degrees angle relative to the Y-axis;
a third position in which the adjustable knob is located at a substantially 180 degrees angle relative to the Y-axis;
a fourth position in which the adjustable knob is located at a substantially 270 degrees angle relative to the Y-axis; and
a fifth position in which the adjustable knob is located at a substantially 359 degrees angle relative to the Y-axis.

10. The pressure washer system of claim 1, wherein the pump is one of an axial pump or a triplex pump.

11. The pressure washer system of claim 10, wherein the pump has a flow rate of between approximately 1-5 gallons per minute.

12. The pressure washer system of claim 11, wherein the pump has a flow rate of between approximately 2-4 gallons per minute.

13. The pressure washer system of claim 10, wherein the pump pumps the liquid from the container at a pressure of between approximately 10-5,000 pounds per square inch.

14. The pressure washer system of claim 13, wherein the pump pumps the liquid from the container at a pressure of between approximately 40-3,500 pounds per square inch.

15. The pressure washer system of claim 10, wherein pressure increases linearly while the adjustable knob is rotated.

16. The pressure washer system of claim 10, wherein pressure increases non-linearly while the adjustable knob is rotated.

17. A method of using a pressure washer system comprising the steps of:
filling a container with a volume of liquid;
controlling flow of the liquid from the container;
pumping at least some of the volume of liquid from the container; and
rotating an adjustable pressure knob between 1 degree and 360 degrees to control pressure of the liquid from the container.

18. The method of claim 17, further comprising the step of moving the adjustable pressure knob between:
a first opened position in which the adjustable pressure knob is at a substantially 1 degree angle relative to the Y-axis in which the liquid is pumped from the container; and
a second closed position in which the adjustable pressure knob is at a substantially 359 degree angle relative to the Y-axis in which the liquid remains within the container.

19. The method of claim 18, further comprising the step of moving the adjustable pressure knob to a plurality of intermediate positions between the first opened position and the second closed position.

20. The method of claim 17, further comprising the steps of:
pumping the liquid at a flow rate of between approximately 2-4 gallons per minute; and
pumping the liquid at a pressure of approximately 40-3,500 pounds per square inch.
